(19) United States
(12) Patent Application Publication
(10) Pub. No.: US 2025/0051498 A1
(43) Pub. Date: Feb. 13, 2025

(54) CROSS-LINKABLE FLUOROPOLYMER

(71) Applicant: Arkema Inc., King of Prussia, PA (US)

(72) Inventor: Yuanqin LIU, King of Prussia, PA (US)

(21) Appl. No.: 18/722,639

(22) PCT Filed: Nov. 16, 2022
(86) PCT No.: PCT/US2022/050023

§ 371 Date: Jun. 21, 2024

Related U.S. Application Data
(60) Provisional application No. 63/293,202, filed on Dec. 23, 2021.

(51) Int. Cl. C08F 214/22; C08F 299/02; C08J 3/24; C08K 5/17; C08K 5/25

(52) U.S. Cl. CPC C08F 214/225; C08F 299/022; C08J 3/24; C08K 5/17; C08K 5/25; C08J 2427/16

(57) ABSTRACT

This invention describes the preparation and characterization of cross-linkable fluoropolymers, These cross-linkable fluoropolymers contain keto functional monomer. The keto functional monomer is incorporated on fluoropolymer while crosslinking agent was post-added after polymerization. The cross-linking reaction occurs after water/solvent evaporation or during melt processing.

### FIELD OF THE INVENTION

The current invention describe a new approach to cross-linked fluoropolymers, which can be prepared in 1K (one-pack self crosslinkable) and applied under room temperature. No heating nor radiation is needed for the cross-link reaction. These features are not shown in any single prior art.

### BACKGROUND OF THE RELATED ART

There are some patents that describe cross-linkable fluoropolymers. But none of them uses a 1 K cross-linking chemistry described in this invention.

RU 2414762 C1 discloses a radiation-cross linked fluoropolymer composition comprising a fluoropolymer, triallyl isocyanurate, and zinc oxide.

WO 2009052163 discloses a fluoropolymer composition comprised of block copolymer containing a hydrofluorocarbon and a polyamide-based crosslinking agent crosslinked at 500° F. (□260° C.). The crosslinked-block copolymer has compatibility with both non-hydrofluorocarbon based fluoropolymers and engineered resins.

JP 3171688 B2 discloses compositions that comprise maleimido group (I) and Fluorine-containing alicyclic structures-polymers and NH2- and Fluorine-containing.alicyclic structures polymers. The compositions are crosslinked by heating at 100-300°.

Fluoropolymers are difficult to crosslink. Usually radiation or high temperature is needed to crosslink fluoropolymers.

Due to the different reactivity, it is very difficult to copolymerize keto-functional monomer such as DAAM or AAEM, with fluorinated monomers. Surprisingly, the present invention demonstrates that keto functional monomers can become part of the polymer either by incorporating into the backbone of a fluoropolymer or by attaching an oligomer (containing the keto functional monomers) to the fluoropolymer through a chain transfer mechanism. The resulting fluorinated keto functional copolymer can react with dihydrazides or diamines, such as Adipic Acid Dihydrazide (ADH) or hexamethylenediamine (HMDA), to form a crosslinked fluoropolymer at ambient temperature or in a melt process.

The present invention uses keto-hydrazide crosslinking, which is based on keto-functional monomers like AAEM (acetoacetoxy ethyl methacrylate) or DAAM (Diacetone Acrylamide) and crosslinking agents such as ADH (adipic acid dihydrazide) or hexamethylenediamine (HMDA).

The invention provides a novel class of fluoropolymers which can be cross-linked during an application process. Cross-linkable fluoropolymers in prior arts usually need special treatment like heating or radiation. The cross-linking chemistry used in this invention does not need heating or radiation. The cross-linking reaction can happen at ambient temperature. In addition, the crosslinking system of the invention is a 1K system, in which all components are packed in one container and the user doesn't need to do any mixing or blending. 1K system is much easier to use compared with 2K cross-linking systems, in which the components are stored in two containers and the user needs to blend them before use.

### BRIEF DESCRIPTION OF THE FIGURES

FIG. 1 is the stress strain curve for Examples 8 and 9

### SUMMARY OF THE INVENTION

The invention provides for a composition comprising a fluorinated keto functional copolymer comprising keto functional monomer units, for example DAAM or AAEM monomer units, as part of the copolymer. The fluorinated keto functional copolymer may be crossed linked. The invention further provides for a method of crosslinking the fluorinated keto functional copolymer by melt processing the fluorinated keto functional copolymer in the presence of dihydrazide or diamine or by providing a solution containing the fluorinated keto functional copolymer and a crosslinking agent followed by drying of the solution.

### Aspects of the Invention

Aspect 1: A composition comprising a fluorinated copolymer, said fluorinated copolymer comprising fluoromonomer units and keto functional monomer units incorporated as part of the polymer.

Aspect 2: The composition of aspect 1, wherein the copolymer comprises at least 95 wt % fluoromonomer units.

Aspect 3: The composition of any one of aspects 1 to 2, wherein the fluoromonomer comprises VDF.

Aspect 4: The composition of any one of aspects 1 to 3, wherein the fluoromonomer comprises HFP.

Aspect 5: The composition of any one of aspects 1 to 4, wherein the keto functional monomer comprises DAAM.

Aspect 6: The composition of any one of aspects 1 to 4, wherein the keto functional monomer comprises AAEM.

Aspect 7: The composition of any one of aspects 1 to 6, wherein the fluorinated copolymer has a melt viscosity of greater than 5 kP, preferably greater than 7 kP.

Aspect 8: The composition of any one of aspects 1 to 7, further comprising a crosslinking agent. Aspect 9: The composition of aspect 8, wherein the crosslinking agent comprises AHD.

Aspect 10: The composition of aspect 8, wherein the crosslinking agent comprises hexamethylenediamine.

Aspect 11: The composition of any one of aspects 1 to 10, wherein the fluorinated copolymer has a toughness of greater than 500,000 lb/in3 (3,450,000 kN m/m3) prior to crosslinking.

Aspect 12: The composition of any one of aspects 1 to 11, wherein the fluorinated copolymer is crosslinked and exhibits an increase in toughness of at least 25%, preferably at least 30%, more preferably at least 35% as compared to the un-crosslinked fluorinated copolymer.

Aspect 13: The composition of any one of aspects 1 to 11, wherein the fluorinated copolymer is crosslinked and exhibits a toughness of greater than 900000 lb/in3 (6,200,000 kN m/m3).

Aspect 14: A method of crosslinking a fluoropolymer, the method comprising providing a fluorinated copolymer comprising keto functional monomer units, blending the fluorinated copolymer with a crosslinking agent, melt processing the blend of the fluorinated copolymer and the cross linking agent.

Aspect 15: A method of crosslinking a fluoropolymer, the method comprising providing, in latex form, a fluorinated copolymer comprising keto functional monomer units, blending crossing linking agent into the latex containing the fluorinated copolymer and then drying the latex.

Aspect 16: The method of any one of aspects 14 to 15, wherein the fluoropolymer comprises vinylidene fluoride monomer units.

Aspect 17: The method of any one of aspects 14 to 16, wherein the fluoropolymer comprises DAAM monomer units.

Aspect 18: The method of any one of aspects 14 to 17, wherein the crosslinking agent comprises a dihydrazide or a diamine.

Aspect 19: The method of any one of aspects 14 to 18, wherein the crosslinking agent comprises AHD.

Aspect 20: The method of any one of aspects 14 to 18, wherein the crosslinking agent comprises hexamethylenediamine.

### DETAILED DESCRIPTION OF THE INVENTION

The references cited in this application are incorporated herein by reference.

Percentages, as used herein are weight percentages (wt. %), unless noted otherwise, and molecular weights are weight average molecular weights (Mw), unless otherwise stated. Molecular weight is measured by gel permeation chromatography (GPC) using PMMA (Polymethylmethacrylate) standards.

Melt viscosity are according to ASTM D3835 by a capillary rheometry at 230° C. and 100 sec-1.

“PVDF” means polyvinylidene fluoride.

“Copolymer” is used to mean a polymer having two or more different monomer units, including terpolymers and higher degree polymers. “Polymer” is used to mean both homopolymer and copolymers. For example, as used herein. “PVDF” and “polyvinylidene fluoride” are used to connote both the homopolymer and copolymers, unless specifically noted otherwise. “Fluoropolymer” is used to mean a polymer comprising fluorinated monomers. The polymers may be homogeneous, heterogeneous, or random, and may have a gradient distribution of co-monomer units.

Ethylenic means the monomer has a polymerizable carbon-carbon double bond.

A keto-functional monomer is an ethylenic monomer that comprises a ketone moiety that when polymerized into the fluoropolymer retains it keto functionality making the keto functionality available for crosslinking. Examples include DAAM or AAEM.

The fluoropolymer of the present invention is a fluorinated keto functional copolymer.

In some embodiments, the present invention relates to a copolymer comprising, in the backbone of the copolymer, keto functional monomer and fluoromonomer, preferably vinylidene fluoride (“VDF”), which can be crosslinked, using a crosslinking agent.

The present invention relates to a process to create a crosslinked fluoropolymer.

An aim of the present invention is to provide a fluoropolymer that can be crosslinked at ambient temperature or during melt processing.

The cross-linkable fluoropolymer of the present invention, containing the keto functionality, can be prepared by two approaches. In the first approach, keto-functional monomer is copolymerized with fluoromonomer to produce fluorinated-keto-functional copolymers. For example VDF can be copolymerized with DAAM to produce a VDF/DAAM copolymer. The crosslinking agent can then be—added, post polymerization, to the copolymer latex or to spray-dried copolymer. In the second approach, keto-functional oligomer is prepared by emulsion polymerization first. This keto-functional oligomer latex is then added to the fluoromonomer polymerization. The fluorinated polymer chain will react with the keto-functional oligomer through a chain transfer mechanism to produce PVDF-b-keto-functional type block copolymers. The crosslinking agent can then be added to the copolymer latex or spray-dried power. In either approach the fluorinated-keto-functional copolymer will cross link upon either being dried (in the case of the latex) or melt processed.

In a preferred embodiment the keto-functional monomer is DAAM and the crosslinking agent is ADH.

### Fluorinated Keto-Functional Copolymer:

The copolymer comprises fluorinated monomer units and keto-functional monomer units. The fluoromonomer units are the majority in the copolymer, accounting for greater than 95 wt % of the total polymer, preferably 95 to 99.99% by weight, more preferably 97 to 99.99% by weight.

The copolymer of the invention does not contain acrylic ester monomers units which do not have keto functionality. The copolymer of the invention may contain acrylic ester monomer units which have keto functionality. The inventive copolymer prior to crosslinking is thermoplastic.

### Monomers:

The present invention incorporates keto-functional monomer or oligomer, such as Diacetone Acrylamide (DAAM), or acetoacetoxy ethyl methacrylate (AAEM) or oligomers thereof, into fluoropolymer. The keto-functional monomers or oligomers provide a ketone functional group to the fluorinated copolymer that can be reacted with a crosslinking agent to provide a crosslinked fluoropolymer.

The invention provides a fluorinated copolymer comprising a fluorinated ethylenic monomer and keto-functional monomer in the backbone of the copolymer or alternative the keto functional monomer is in the form of an oligomer that is attached to the fluoropolymer. This can be accomplished by two approaches. First, the keto-functional monomer and fluorinated monomer can be copolymerized directly. Second, an oligomer comprising keto-functional monomer is prepared first and then fluorinated monomer can be polymerized in the presence of the keto-functional oligomer to form a copolymer. Preferably the keto-functional monomer is DAAM or AAEM.

Example fluorinated ethylenic monomers “fluoromonomers” may be selected from the group consisting of vinylidene fluoride (VDF), tetrafluoroethylene (TFE), trifluoroethylene (TrFE), chlorotrifluoroethylene (CTFE), 1,2-difluoroethylene, perfluorobutylethylene (PFBE), hexafluoropropene (HFP), vinyl fluoride (VF), pentafluoropropene, 2,3,3,3-tetrafluoropropene, trifluoropropene, fluorinated (alkyl) vinyl ethers, such as, perfluoroethyl vinyl ether (PEVE), and perfluoro-2-propoxypropyl vinyl ether, perfluoromethyl vinyl ether (PMVE), perfluoropropyl vinyl ether (PPVE), perfluorobutylvinyl ether (PBVE), longer chain perfluorinated vinyl ethers, one or more of partly or fully fluorinated alpha-olefins such as 3,3,3-trifluoro-1-propene, 2-trifluoromethyl-3,3,3-trifluoropropene, 1,2,3,3,3-pentafluoropropene, 3,3,3,4,4-pentafluoro-1-butene, hexafluoroisobutylene (HFIB), fluorinated dioxoles, such as perfluoro (1,3-dioxole) and perfluoro (2,2-dimethyl-1,3-dioxole) (PDD), partially- or per-fluorinated alpha olefins of C4 and higher, partially- or per-fluorinated cyclic alkenes of C3 and higher, partly fluorinated allylic, or fluorinated allylic monomers, and combinations thereof.

Other monomers units in these polymers may include any monomer that contains a polymerizable C═C double bond. Additional monomers could be 2-hydroxyethyl allyl ether, 3-allyloxypropanediol, allylic monomers, ethane, propene, acrylic acid, methacrylic acid.

Non-limiting examples of the fluorinated keto functional copolymers in the compositions of the present invention include polyvinylidene fluoride (PVDF), polyhexafluoropropylene (PHFP), chlorotrifluoroethylene (CTFE), polytetrafluoroethylene (PTFE), polyperfluoromethylvinylether (PMVE), and combinations thereof, as well as copolymers and terpolymers thereof.

Preferably the fluorinated keto functional copolymer of the invention comprises equal to or greater than 75 weight percent of vinylidene fluoride monomer units by weight. The fluoropolymer may contain co fluoromonomers. For example, a predominately VDF copolymer may also contain HFP or TFE. Preferred comonomers include TFE, HFP, 2,3,3,3-tetrafluoropropene “1234 yf”, and 1,3,3,3-tetrafluoropropene.

Vinylidene fluoride copolymers include those containing at least at least 75 weight %, preferably at least 80 weight %, and more preferably at least 95 weight % of vinylidene fluoride copolymerized with keto functional co monomer and one or more fluorinated comonomers.

In one preferred embodiment the fluorinated keto functional copolymer is also acid functionalized, preferably acid functionalized PVDF.

Methods of producing acid functionalized fluoropolymers are known in the art. WO2019/199753, WO2016149238 and U.S. Pat. No. 8,337,725, the content of each are herein incorporated by reference, provide some known methods of producing acid functionalized fluorinated polymers.

In some embodiments the copolymer is VDF/HFP/DAAM or VDF/HFP/AAEM containing up to 29.99%, preferably up to 24.99%, and more preferably up to 19.99% by weight or up to 9.99% by weight of hexafluoropropene (HFP) units based on total monomer units. In all cases the amount of DAAM or AAEM will be at least 0.01 wt percent and the total wt % monomer units in the copolymer will add up to 100%.

Preferably, the keto functional fluorinated copolymer is such that the melt viscosity is at least 5 kPoise or greater, preferably at least 7 kPoise or greater prior to crosslinking. In some embodiments the melt viscosity is at least 10 kPoise or greater prior to crosslinking.

### Polymerization Process

Fluoropolymers, such as polyvinylidene-based polymers, can be made by any process known in the art, preferably using aqueous free-radical emulsion polymerization—although suspension, solution and supercritical CO₂ polymerization processes may also be used. Processes such as emulsion and suspension polymerization are preferred and are described in U.S. Pat. No. 6,187,885, and EP 0120524. It is preferred that the keto functional fluorinated copolymer is made by emulsion polymerization.

In a general emulsion polymerization process, a reactor is charged with deionized water, optionally water-soluble surfactant capable of emulsifying the reactant mass during polymerization and optional paraffin wax antifoulant. The mixture is stirred and deoxygenated. A predetermined amount of optional chain transfer agent, CTA, is then introduced into the reactor, the reactor temperature raised to the desired level and monomer (for example a fluorinated monomer such as vinylidene fluoride, keto functional monomer and possibly one or more other comonomers) are fed into the reactor. Once the initial charge of monomer is introduced and the pressure in the reactor has reached the desired level, an initiator is introduced to start the polymerization reaction. The temperature of the reaction can vary depending on the characteristics of the initiator used and one of skill in the art will know how to do so. Typically, the temperature will be from about 30° to 150° C. preferably from about 60° to 120° C. Once the desired amount of polymer has been reached in the reactor, the monomer feed will be stopped, but initiator feed is optionally continued to consume residual monomer. Residual gases (containing unreacted monomers) are vented and the latex recovered from the reactor.

### Surfactant:

Preferably the polymerization of the present invention is performed in the absence of a surfactant. Although surfactant can be added to the polymerization process.

If used, the surfactant used in the polymerization can be any surfactant known in the art to be useful in PVDF emulsion polymerization, including perfluorinated, partially fluorinated, and non-fluorinated surfactants. Preferably, the PVDF emulsion is fluorosurfactant free, with no fluorosurfactants being used in any part of the polymerization. Non-fluorinated surfactants useful in the PVDF polymerization could be both ionic and non-ionic in nature including, but are not limited to, 3-allyloxy-2-hydroxy-1-propane sulfonic acid salt, polyvinylphosphonic acid, polyvinyl sulfonic acid, and salts thereof, polyethylene glycol and/or polypropylene glycol and the block copolymers thereof, alkyl phosphonates and siloxane-based surfactants.

### Chain Transfer Agent:

A chain-transfer agent may be added to the polymerization to regulate the molecular weight of the product. They may added to a polymerization in a single portion at the beginning of the reaction, or incrementally or continuously throughout the reaction. The amount and mode of addition of chain-transfer agent depend on the activity of the particular chain-transfer agent employed, and on the desired molecular weight of the polymer product. The amount of chain-transfer agent added to the polymerization reaction is from about 0 to 5 wt %, preferably 0.05 to about 5 weight percent, more preferably from about 0.1 to about 2 weight percent based on the total weight of monomer added to the reaction mixture. Examples of chain transfer agents useful in the present invention include, but are not limited to oxygenated compounds such as alcohols (preferably having 3 to 10 carbons), carbonates, ketones, esters, and ethers may serve as chain-transfer agents such as acetone, ethylacetate, diethylether, methyl-ter-butyl ether, isopropyl alcohol; bis(alkyl)carbonates wherein the alkyl has from 1 to 9 carbon atoms, such as bis(ethyl)carbonate, bis(isobutyl)-carbonate; ethane, propane, and those described in US2018/0072829, low molecular weight polymer chain transfer agents containing one or more different functional groups including but not limited to, polyacrylic acid, polylactic acid, poly phosphonic acid, polysulfonic acid, and polymaleic acid. Some surfactants may also function as a chain transfer agent.

A paraffin antifoulant may be employed, if desired, although it is not preferred, and any long-chain, saturated, hydrocarbon wax or oil may be used. Reactor loadings of the paraffin may be from 0.01% to 0.3% by weight on the total monomer weight used.

### Buffering Agent:

The polymerization reaction mixture may optionally contain a buffering agent to maintain a controlled pH throughout the polymerization reaction. The pH is preferably controlled within the range of from about 4 to about 8, to minimize undesirable color development in the product.

Buffering agents may comprise an organic or inorganic acid or alkali metal salt thereof, or base or salt of such organic or inorganic acid, that has at least one pKₐ value and/or pK_{b} value in the range of from about 4 to about 10, preferably from about 4.5 to about 9.5. Preferred buffering agents in the practice of the invention include, for example, phosphate buffers and acetate buffers. A “phosphate buffer” is a salt or salts of phosphoric acid. An “acetate buffer” is a salt of acetic acid.

The polymerization results in a latex generally having a solids level of 10 to 60 percent by weight, preferably 10 to 50%, and having an intensity average primary particle size of less than 500 nm, preferably less than 400 nm, and more preferably less than 300 nm. The intensity average particle size is generally at least 20 nm and preferably at least 50 nm. The fluoropolymer particles in the dispersion have a primary particle size in the range of 50 to 600 nm, and preferable from 100-500 nm. Latex primary particle size is measured by dynamic light scattering using a NICOMP™ 380 submicron particle sizer. The data is reported as intensity average particle size (diameter).

The polymer or copolymer can be isolated using standard methods such as oven drying, spray drying, shear or acid coagulation followed by drying, or kept in the aqueous media for subsequent application or use.

### Cross Linking Agent:

Dihydrazides or diamines are the preferred crosslinking agents in the present invention. In particular adipic acid dihydrazide (ADH) and hexamethylenediamine (HMDA) are most preferred.

### Cross Linking the Fluorinated Keto Functional Copolymer:

The keto functional monomer is incorporated into fluoropolymer during polymer preparation usually an emulsion polymerization process, while cross linking agent is post-added to the fluorinated keto functional copolymer after polymerization. Each cross linking agent can react with two keto functional groups to cross-link the fluorinated keto functional copolymer chains. The cross-linking reaction will occur after water/solvent evaporation or during melt processing.

The fluorinated keto functional copolymer can be cross linked, either in latex form or melt processing in powder form.

The fluorinated keto functional copolymer in latex form can be combined with cross linking agent (preferably ADH-which is water soluble) resulting in an aqueous composition of fluorinated keto functional copolymer and dissolved crosslinking agent. Upon drying of the latex, the cross linking agent will react with the keto functional monomer in the fluoropolymer resulting in crosslinking of the polymer. Heating or vacuum is not required but can be used to speed drying. As an example, the fluorinated keto functional copolymer can be used in a coating process. A latex composition containing the fluorinated keto functional copolymer can be coated onto a substrate and dried. Upon drying the crosslinking agent reacts with the keto functionality resulting in crosslinking.

The fluorinated keto functional copolymer can also be spray dried into powder and then be crosslinked by blending the keto functional copolymer with a crosslinking agent that reacts with the keto functionality in the copolymer when melt processed. The fluorinated keto functional copolymer is generally melt processed at a temperature of at least 20 degrees above the melting point of the fluorinated keto functional copolymer. Upon melting of the keto functional copolymer, the cross linking agent reacts with the keto functionality in the fluoropolymer resulting in crosslinking. In one embodiment, the keto functional unit comprises DAAM and the crosslinking agent comprises ADH. Melt processing includes extrusion and melt molding. Any process where the copolymer is melted and formed into a shape can be used.

After cross-linking, the fluorinated keto functional copolymer shows higher Melt viscosity and improved mechanical properties. The melt viscosity increases by at least 50% and the toughness increase by at least 20%, preferably 30% compared to the same copolymer prior to crosslinking. Preferably the fluorinated copolymer has a toughness of greater than 500,000 lb/in3 (3,450,000 kN m/m3) prior to crosslinking. Preferably the fluorinated copolymer has a toughness of greater than 900,000 lb/in3 (6,200,000 kN m/m3) after crosslinking.

### Uses

The fluorinated keto functional copolymer of the invention can be potentially used in many applications such as coatings, industrial parts, chemical processing, and membrane.

The fluorinated keto functional copolymer of the invention can be used to make coatings. Such coating are resistant to permeation of chemicals.

In a further aspect, the present invention also relates to an article made from a composition comprising the fluorinated keto functional copolymer.

In a further aspect, the present invention relates to a method for the manufacture of a shaped article, said method comprising processing a composition comprising the fluorinated keto functional copolymer.

The inventive fluorinated keto functional copolymer can be fabricated into the desired shaped article, e.g. by moulding (injection moulding, extrusion moulding), calendering, or extrusion.

The fluorinated keto functional copolymer of the present invention can be used in various applications such as battery and coating.

The present invention, its characteristics and the various advantages which it provides will become more clearly apparent on reading the examples which follow and which are provided as explanatory and nonlimiting examples.

### EXAMPLES

Melt viscosity (“MV”) measurements of resin were performed with a DYNISCO LCR-7000 according to ASTM D3835 by a capillary rheometry at 230° C. and 100 sec⁻¹.

Light scattering test method for latex particle size: Nicomp CW380 Particle Size Analyzer (light scattering) is used to measure the particle size of the latex particles. The Volume Average particle size is used.

Percent incorporation of keto functional monomer (DAAM) into PVDF was determined by 19F-NMR.

Test Method for stress at Yield, Stress at break, Toughness and Young's Modulus were measured according to ASTM D683, 23C, 50 mm/min using a type 1 tensile bars.

### Example 1. Preparation of VDF-DAAM Copolymer

To a 2 gallon autoclave were added 3000 g of deionized water. The autoclave was purged with Argon/Nitrogen 3 times (stop agitation during venting), followed with low flow rate Argon/Nitrogen purge for 15 min at low agitator 15 rpm. The autoclave was sealed and agitated at 72 rpm, heated to 100 C and pressurized to 650 psi with vinylidene fluoride. A feed of 3.0 wt % potassium persulfate (KPS) and 1.0 wt % sodium acetate (SAT) aqueous solution was started at 60.0 mL/h. Upon start of pressure drop, the KPS/SAT feed rate was reduced to 25.0 mL/h and the pressure was maintained by additional VDF feed. A feed of 5.0 wt % DAAM solution was started at 150.0 mL/h until 1700 mL VDF total. Feeds were continued in this fashion, until a total of 1800 g of VDF had been fed to the autoclave. The reaction temperature was reduced to 83 C for additional 30 minutes with KPS/SAT feed at 10.0 mL/h. Then the pressure was allowed to autogenously decrease for 10 minutes at which point the reactor was vented to atmospheric pressure and cooled to room temperature. Product was discharged from the reactor and spray-dried. ADH can be added before or after spray drying at a molar ratio of DAAM/ADH=2/1. Particle size 217 nm. By light scattering

This example show that a VDF/DAAM copolymer can be made. Table 1 show that after crosslinking with ADH the MV is more than doubled.

### Example 2. Preparation of VDF-HFP-DAAM Copolymer (No Surfactant)

To a 2 gallon autoclave were added 3200 g of deionized water. The autoclave was purged with Argon/Nitrogen 3 times (stop agitation during venting), followed with low flow rate Argon/Nitrogen purge for 15 min at low agitator 15 rpm. The autoclave was sealed and agitated at 72 rpm, heated to 100 C and pressurized to 650 psi with 58 mL of HFP and 494 mL of vinylidene fluoride. A feed of 3.0 wt % potassium persulfate (KPS) and 1.0 wt % sodium acetate (SAT) aqueous solution was started at 60.0 mL/h. Upon start of pressure drop, the KPS/SAT feed rate was reduced to 25.0 mL/h and the pressure was maintained by additional VDF feed. HFP was fed at 30.0 mL/h until 108.0 mL HFP total. A feed of 5.0 wt % DAAM solution was started at 150.0 mL/h until 1700 mL VDF total. Feeds were continued in this fashion, until a total of 1800 g of VDF had been fed to the reactor. The reaction temperature was reduced to 83 C for additional 30 minutes with KPS/SAT feed at 10.0 mL/h. Then the pressure was allowed to autogenously decrease for 10 minutes at which point the reactor was vented to atmospheric pressure and cooled to room temperature. Product was discharged from the reactor and spray-dried. 300 nm by light scattering

This show that a copolymer of VDF/HFP/DAAM can be produced. Table 1 show that after crosslinking with ADH the MV is more than doubled.

### Example 3. Preparation of VDF-HFP-DAAM Copolymer with PAA Functionality

To a 2 gallon autoclave were added 3200 g of deionized water. The autoclave was purged with Argon/Nitrogen 3 times (stop agitation during venting), followed with low flow rate Argon/Nitrogen purge for 15 min at low agitator 15 rpm. The autoclave was sealed and agitated at 72 rpm, heated to 100 C and pressurized to 650 psi with 58 mL of HFP and 494 mL of vinylidene fluoride. A feed of 3.0 wt % potassium persulfate (KPS) and 5.0 wt % poly(acrylic acid) (PAA) aqueous solution was started at 120.0 mL/h. Upon start of pressure drop, the KPS/SAT feed rate was reduced to 30.0 mL/h and the pressure was maintained by additional VDF feed. HFP was fed at 30.0 mL/h until 108.0 mL HFP total. A feed of 5.0 wt % DAAM solution was started at 200.0 mL/h until 1650 mL VDF total. Feeds were continued in this fashion, until a total of 1700 g of VDF had been fed to the reactor. The reaction temperature was maintained at 100 C for additional 30 minutes with KPS/SAT feed at 10.0 mL/h. Then the pressure was allowed to autogenously decrease for 10 minutes at which point the reactor was vented to atmospheric pressure and cooled to room temperature. Product was discharged from the reactor and spray-dried. 218 nm particle size.

This shows that a copolymer of VDF/HFP/DAAM with acid functionality can be produced. Table 1 show that after crosslinking with ADH the MV is more than doubled.

### Impact of Cross-Linking on Melt Viscosity:

Melt viscosity (MV) of VDF-DAAM and VDF-HFP-DAAM copolymers (Examples 1, 2 and 3) were measured with and without addition of ADH. Without ADH the copolymers are not cross-linked. All three copolymers have a MV of mid 20 kP. Addition of ADH was achieved by sealing the copolymer powder (spray dried powder) and ADH powder in a plastic container and shaking the container for 30 minutes. Then melt viscosity was measured on the powder blend. DAAm/ADH cross-linking occurred during the melt process. After cross-linking the MV increased significantly.

TABLE 1
Melt viscosity of VDF-DAAM Copolymers

| | | | | | | MV |
|---|---|---|---|---|---|---|
| Sample | | HFP | PAA | DAAM | MV | w/ADH |
| ID | Description | % | % | % | (kP) | (kP) |
| Example 1 | VDF-DAAM | — | — | 0.72 | 23.2 | 47.5 |
| | copolymer | | | | | |
| Example 2 | VDF-HFP-DAAM | 5.7 | — | 1.00 | 24.4 | 49.7 |
| | copolymer | | | | | |
| Example 3 | VDF-HFP-DAAM | 6.0 | 0.36 | 0.75 | 26.2 | 59.6 |
| | copolymer with | | | | | |
| | PAA | | | | | |
| | functionality | | | | | |

### Example 4. Preparation of VDF-HFP-DAAM Copolymer Latex

To a 2 gallon autoclave were added 2650 g of deionized water and 2.9 g of Sartomer® SR604 polypropylene glycol monomethacrylate (PPGMA) surfactant. The autoclave was purged with Argon/Nitrogen 3 times (stop agitation during venting), followed with low flow rate Argon/Nitrogen purge for 15 min at low agitator 15 rpm. The autoclave was sealed and agitated at 72 rpm, heated to 100 C and pressurized to 650 psi with 220.0 mL of HFP and vinylidene fluoride. A feed of 4.0 wt % potassium persulfate (KPS) and 4.0 wt % sodium acetate (SAT) aqueous solution was started at 240.0 mL/h. Upon start of pressure drop, the KPS/SAT feed rate was reduced to 15.0 mL/h and the pressure was maintained by additional VDF feed. HFP was fed at 150.0 mL/h until 420.0 mL HFP total. A feed of 5.0 wt % DAAM solution was started at 200.0 mL/h until 1400 mL VDF total. Feeds were continued in this fashion, until a total of 1480 g of VDF had been fed to the reactor. The reaction temperature was maintained at 83 C for additional 40 minutes. Then the pressure was allowed to autogenously decrease for 10 minutes at which point the reactor was vented to atmospheric pressure and cooled to room temperature. 60.0 g of 30.0 wt % ALS (ammonium lauryl sulfate (surfactant)) solution was added to the reactor with agitation 30 rpm. Product was discharged from the reactor. Particle size is 125 nm. Solids is 35%. Melt Viscosity is 11.4 kPoise 232 C at 100 sec-1. Molecular weight is Mn 170,000 g/mol. Melting temperature is 112.5 C. % HFP is 18.1 wt % by F-NMR.

This show that a copolymer of VDF/HFP/DAAM can be produced. The addition of the surfactant decreased the particle size.

### Example 5A. Preparation of p-DAAM Oligomer Latex

To a 2 liter reactor were added 800 g of deionized water. The reactor was purged with nitrogen. The reactor was agitated at 160 rpm and heated to 80 C. (Atmospheric pressure) 60.0 g of 16.7 wt % ammonium persulfate (APS) aqueous solution was added to the reactor as a shot. Monomer mixture (20.0 g of DAAM, 2.0 g of Acrylic acid (“AA”), 250.0 g of DI water) feed was started at 272.0 mL/h. After the monomer mixture feed was completed, the reaction temperature was maintained at 80 C for additional 30 minutes. Then the reactor was cooled to room temperature. Agitation was stopped and latex product was discharged from the reactor. This p-DAAM latex was directly used in the preparation of PVDF-b-pDAAM block copolymer without further purification. This p-DAAM oligomer has a Mn 1600 g/mol by GPC using polymethylmethacrylate standard.

### Example 5B. Preparation of PVDF with DAAM Functionality Copolymer

To a 2 gallon autoclave were added 3200 g of deionized water and 300.0 g of 2.5 wt % p-DAAM oligomer latex (from Example 5A). The autoclave was purged with Argon/Nitrogen 3 times (stop agitation during venting), followed with low flow rate Argon/Nitrogen purge for 15 min at low agitator 15 rpm. The autoclave was sealed and agitated at 72 rpm, heated to 100 C and pressurized to 650 psi with vinylidene fluoride. A feed of 3.0 wt % potassium persulfate (KPS) aqueous solution was started at 100.0 mL/h. Upon start of pressure drop, the KPS feed rate was reduced to 25.0 mL/h and the pressure was maintained by additional VDF feed. Additional 500.0 g of 2.5 wt % p-DAAM oligomer latex was fed at 350.0 mL/h. Feeds were continued in this fashion, until a total of 1800.0 g of VDF had been fed to the reactor. The reaction temperature was maintained at 100 C for additional 30 minutes with KPS feed at 15.0 mL/h. Then the pressure was allowed to autogenously decrease for 10 minutes at which point the reactor was vented to atmospheric pressure and cooled to room temperature. Product was discharged from the reactor and spray-dried. This copolymer has a melt viscosity of 34.9 kP before crosslinking and 48.9 kP after cross-linked by addition of ADH at a molar ratio of DAAM/ADH=2/1 based on amount fed into the reactor.

This show that the DAAM can be incorporated into the PVDF polymer via a chain transfer action.

### Example 6. Preparation of VDF-DAAM Copolymer

To a 2 gallon autoclave were added 3000 g of deionized water and 7.4 g of PAA aqueous solution (PAA CP-10s, 50 wt % aqueous solution). The autoclave was purged with Argon/Nitrogen 3 times (stop agitation during venting), followed with low flow rate Argon/Nitrogen purge for 15 min at low agitator 15 rpm. The autoclave was sealed and agitated at 72 rpm, heated to 100 C and pressurized to 650 psi with vinylidene fluoride. A feed of 4.0 wt % potassium persulfate (KPS) and 1.0 wt % sodium acetate (SAT) aqueous solution was started at 60.0 mL/h. Upon start of pressure drop, the KPS/SAT feed rate was reduced to 25.0 mL/h and the pressure was maintained by additional VDF feed. A feed of 5.0 wt % DAAM solution was started at 150.0 mL/h until 1700 mL VDF total. Feeds were continued in this fashion, until a total of 1800 g of VDF had been fed to the autoclave. The reaction temperature was reduced to 83 C for additional 30 minutes with KPS feed at 10.0 mL/h. Then the pressure was allowed to autogenously decrease for 10 minutes at which point the reactor was vented to atmospheric pressure and cooled to room temperature. Product was discharged from the reactor and spray-dried. ADH can be added before or after spray drying at a molar ratio of DAAM/ADH=2/1. Latex particle size is 249 nm by light scattering. This copolymer has a melt viscosity of 8.8 kP by itself and 18.6 kP after cross-linked by ADH.

### Example 7. Preparation of VDF-DAAM Copolymer

To a 2 gallon autoclave were added 3000 g of deionized water and 3.4 g of PAA aqueous solution (PAA CP-10s, 50 wt % aqueous solution). The autoclave was purged with Argon/Nitrogen 3 times (stop agitation during venting), followed with low flow rate Argon/Nitrogen purge for 15 min at low agitator 15 rpm. The autoclave was sealed and agitated at 72 rpm, heated to 100 C and pressurized to 650 psi with vinylidene fluoride. A feed of 3.0 wt % potassium persulfate (KPS) and 1.0 wt % sodium acetate (SAT) aqueous solution was started at 60.0 mL/h. Upon start of pressure drop, the KPS/SAT feed rate was reduced to 25.0 mL/h and the pressure was maintained by additional VDF feed. A feed of 5.0 wt % DAAM solution was started at 150.0 mL/h until 1700 mL VDF total. Feeds were continued in this fashion, until a total of 1800 g of VDF had been fed to the autoclave. The reaction temperature was reduced to 83 C for additional 30 minutes with KPS feed at 10.0 mL/h. Then the pressure was allowed to autogenously decrease for 10 minutes at which point the reactor was vented to atmospheric pressure and cooled to room temperature. Product was discharged from the reactor and spray-dried. ADH can be added before or after spray drying at a molar ratio of DAAM/ADH=2/1. Latex particle size is 233 nm by light scattering. This copolymer has a melt viscosity of 27.8 kP by itself and 47.5 kP after cross-linked by ADH.

### Determination of Incorporation of DAAM in Fluoropolymer:

Incorporation of DAAM in PVDF was confirmed by NMR. 13% of total DAAM feed was copolymerized with VDF.

TABLE 2
Characterization of VDF-DAAM Copolymer by NMR

| | | | Total | | |
|---|---|---|---|---|---|
| | | VDF | Feed | Incorporated | DAAM |
| | | (wt | DAAM | DAAM | incorporation |
| Exp. ID | Description | %) | (wt %) | (wt %) | (%) |
| Example | VDF-DAAm | 99.3 | 0.7 | 0.09 | 13 |
| 6 | copolymer | | | | |
| Example | VDF-DAAm | 99.7 | 0.3 | 0.04 | 13 |
| 7 | copolymer | | | | |

### Example 8. Preparation of VDF-DAAM Copolymer

This sample was prepared in the same way as Example 1. The obtained copolymer latex was spray dried without adding any ADH. The dried copolymer has a melt viscosity of 20.1 kP.

### Example 9. Preparation of VDF-DAAM Copolymer

This sample was prepared in the same way as Example 1. The obtained copolymer latex was spray dried with ADH (molar ratio of DAAM/ADH=2/1). The dried copolymer has a melt viscosity of 43.1 kP.

### Impact of Cross-Linking on Tensile Strength

Tensile strength of VDF-DAAM copolymers were measured with and without addition of ADH. (Example 8) was spray dried without ADH-copolymer was not cross-linked. For Example 9, ADH was added to the copolymer latex and then spray dried. Thus Example 9 was cross-linked. Tensile properties were tested on these two samples

TABLE 3
Summary of Tensile strength of cross-linkable PVDF

| | Stress | Strain | Stress | Strain | | |
|---|---|---|---|---|---|---|
| | at | at | at | at | Young's | Toughness |
| | Yield | Yield | Break | Break | Modulus | (kN · |
| Samples | (N/m²) | (%) | (N/m²) | (%) | (N/m²) | m · m⁻³) |
| Example 8 | 4.31 × | 9.40 | 2.78 × | 252 | 1.45 × | 5,382,881 |
| Not | 10⁷ | | 10⁷ | | 10⁹ | |
| crosslinked | | | | | | |
| Example 9 | 4.36 × | 9.60 | 2.84 × | 171 | 1.52 × | 7,789,490 |
| cross-linked | 10⁷ | | 10⁷ | | 10⁹ | |

The stress @ Yield, strain @ Yield, and Young's Modulus are similar for these two copolymers.

The Toughness of the cross-linked copolymer (Example 9) is significantly (45%) higher than the uncrosslinked copolymer (Example 8) since Example 9 break at much longer Strain.

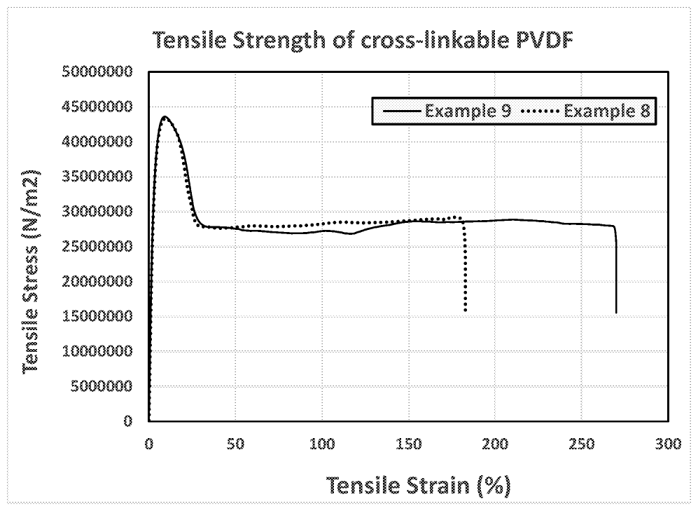

The curves are shown in FIG. 1.

1. A composition comprising a fluorinated copolymer, said fluorinated copolymer comprising fluoromonomer units and keto functional monomer units incorporated as part of the polymer.

2. The composition of claim 1, wherein the copolymer comprises at least 95 wt % fluoromonomer units.

3. The composition of claim 1, wherein the fluoromonomer comprises VDF.

4. The composition of claim 1, wherein the fluoromonomer comprises HFP.

5. The composition of claim 1, wherein the keto functional monomer comprises DAAM.

6. The composition of claim 1, wherein the keto functional monomer comprises AAEM.

7. The composition of claim 1, wherein the fluorinated copolymer has a melt viscosity of greater than 5 kP.

8. The composition of claim 1, further comprising a crosslinking agent.

9. The composition of claim 8, wherein the crosslinking agent comprises AHD.

10. The composition of claim 8, wherein the crosslinking agent comprises hexamethylenediamine.

11. The composition of claim 1, wherein the fluorinated copolymer has a toughness of greater than 500,000 lb/in3 (3,450,000 kN m/m3) prior to crosslinking.

12. The composition of claim 7, wherein the fluorinated copolymer is crosslinked and exhibits an increase in toughness of at least 25% as compared to the un-crosslinked fluorinated copolymer.

13. The composition of claim 7, wherein the fluorinated copolymer is crosslinked and exhibits a toughness of greater than 900000 lb/in3 (6,200,000 kN m/m3).

14. A method of crosslinking a fluoropolymer, the method comprising providing a fluorinated copolymer comprising keto functional monomer units, blending the fluorinated copolymer with a crosslinking agent, melt processing the blend of the fluorinated copolymer and the cross linking agent.

15. A method of crosslinking a fluoropolymer, the method comprising providing, in latex form, a fluorinated copolymer comprising keto functional monomer units, blending crossing linking agent into the latex containing the fluorinated copolymer and then drying the latex.

16. The method of claim 14, wherein the fluoropolymer comprises vinylidene fluoride monomer units.

17. The method of claim 14, wherein the fluoropolymer comprises DAAM monomer units.

18. The method of claim 14, wherein the crosslinking agent comprises a dihydrazide or a diamine, preferably AHD.

19. The method of claim 14, wherein the crosslinking agent comprises AHD.

20. The method of claim 14, wherein the crosslinking agent comprises hexamethylenediamine.
